(19) United States
(12) Patent Application Publication
(10) Pub. No.: US 2007/0160227 A1
(43) Pub. Date: Jul. 12, 2007

(54) Sound control device

(76) Inventors: Satoshi Kogure, Iwaki-city (JP); Tetsu Kanamori, Iwaki-city (JP); Toshio Inoue, Wako-shi (JP); Akira Takahashi, Wako-shi (JP); Kosuke Sakamoto, Wako-shi (JP); Yasunori Kobayashi, Wako-shi (JP)

Correspondence Address: SLATER & MATSIL, L.L.P., 17950 PRESTON RD, SUITE 1000, DALLAS, TX, 75252-5793, US

(21) Appl. No.: 11/652,298

(22) Filed: Jan. 11, 2007

(30) Foreign Application Priority Data
Jan. 11, 2006 (JP) 2006-003614

(51) Int. Cl. H04B 1/00

(52) U.S. Cl. 381/86

(57) ABSTRACT

A microcomputer 12 selectively generates signals corresponding to a cancel sound and a pseudo-engine sound respectively based on a rotation number of an engine and causes a switch 23 of a subsequence attenuator ATT 16 to be in an ON condition for attenuating the signal corresponding to the cancel sound if it is generated and causes the switch 23 to be in an OFF condition for passing the signal corresponding to the pseudo-engine sound through it if it is generated.

This application claims priority to Japanese Patent Application 2006-003614, which was filed Jan. 11, 2006, and is incorporated herein by reference.

### TECHNICAL FIELD

The present invention relates to a sound control device for controlling the sound in an interior of a vehicle.

### BACKGROUND

An ANC (Active Noise Control), which outputs a cancel sound with a reverse phase of an engine sound to the interior of the vehicle, is known as a technology for keeping the vehicle interior quiet by reducing the engine sound in the interior of the vehicle. For example, Japanese Laid-Open 06-175667 discloses ANC technology. On the other hand, an ASC (Active Sound Control), which outputs a pseudo-engine sound corresponding to an engine revolution number to the interior of the vehicle, has been proposed as a technology for providing an exhilarating feeling to a driver by providing an optional engine sound to the interior of the vehicle. As an example, Japanese Laid-open 06-289887 discloses ASC technology.

However, the conventional sound controls of ANC and ASC are performed by an individual device. The entire size of the devices tends to be large when both sound controls of ANC and ASC are performed. The large size of the devices causes a problem with installation within limited spaces, especially the interior of the vehicle.

### SUMMARY OF THE INVENTION

In various aspects, the present invention is provided to resolve the conventional problem mentioned above, and aims to provide a downsized sound control device that performs the sound controls of ANC and ASC with ease.

In a first embodiment, a sound control device of the present invention is installed in an interior of a vehicle, for controlling the sound in the interior of the vehicle. This device includes cancel sound signal generating means for generating a signal corresponding to the cancel sound for canceling an engine sound based on an engine revolution number when the engine revolution number is in a first range, and pseudo-engine sound generation means for generating a signal corresponding to a pseudo-engine sound based on the engine revolution number when the engine revolution number is in a second range, the second range not overlapped with the first range.

According to this, both sound controls, which are ANC for canceling the engine sound and ASC for outputting the pseudo-engine sound, are performed by a single device, the miniaturized device can be achieved.

In another embodiment, a sound control device of the present invention is installed in an interior of a vehicle, for controlling the sound in the interior of the vehicle. This embodiment device includes sound signal generation means for generating a signal corresponding to a pseudo-engine sound and a signal corresponding to a cancel sound for canceling an engine sound selectively based on an engine revolution number, and attenuating means for receiving the signals corresponding to the cancel sound and to the pseudo-engine sound generated by the sound signal generation means and for attenuating only the signal corresponding to the cancel sound.

According to this, sound signal generation means is commonly used for the sound controls of ANC and ASC, and the attenuating means is only operated at the sound control of ANC. As a result, the sound controls of ANC and ASC are performed by one device and the miniaturized device can be achieved.

Since the signal corresponding to the pseudo-engine sound is high amplitude and the signal corresponding to the cancel sound is low amplitude in general, the dynamic range of the sound signal in the sound signal generation means becomes large. Consequently the quantifying noise may not be negligible if the cancel sound is low amplitude. On the contrary, the sound signal generation means of the present invention maintains the signal corresponding to the cancel sound at a high amplitude for outputting and subsequently attenuating means can attenuate it, thus the amplitude of the sound signal in the sound signal generation means can be increased and the quantifying noise can be reduced.

From a similar point of view, the sound control device of the present invention may have a control means for controlling an operation of the attenuating means based on the engine revolution number.

Furthermore, the attenuating means may include a switch whose one end is coupled to an output of the sound signal generation means and the other end is coupled to ground, and the control means makes the switch an ON condition for attenuating the signal corresponding to the cancel sound if it is generated by the sound signal generation means.

According to embodiments of the present invention, the sound controls, which are ANC for canceling the engine sound and ASC for outputting the pseudo-engine sound, are performed by a single device, and the miniaturization of the device can be achieved.

### BRIEF DESCRIPTION OF THE DRAWINGS

A description will now be given, with reference to the accompanying drawings, of embodiments of the present invention.

FIG. 1 shows a block diagram of a sound control device according to an embodiment of the present invention;

FIG. 2 shows a relationship between engine revolution number and sound controls of ANC and ASC;

FIG. 3 is an example of a table which shows a relationship between engine revolution number and output signal; and

FIG. 4 shows circuitry of attenuator (ATT).

The following list of reference symbols can be used in conjunction with the figures:

| | |
|---|---|
| 10 | sound control device |
| 12 | microcomputer |
| 14 | LPF |
| 16 | ATT |
| 18 | AMP |
| 19 | microphone |
| 20 | engine controller |
| 21, 22 | resistor |
| 23 | switch |

### DETAILED DESCRIPTION OF ILLUSTRATIVE EMBODIMENTS

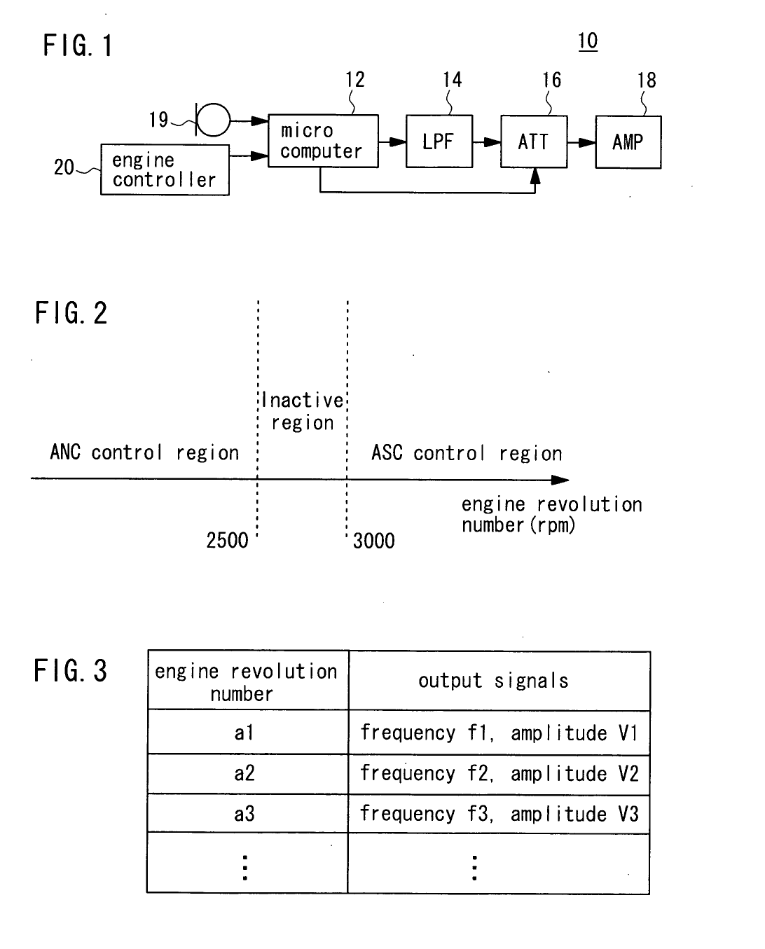

FIG. 1 shows a block diagram of a sound control device according to an embodiment of the present invention. A sound control device 10 in FIG. 1 outputs a cancel sound to an interior of a vehicle by a sound control of ANC and outputs a pseudo-engine sound to the interior of the vehicle by a sound control of ASC. The sound control device 10 includes a microcomputer 12, a low pass filter (LPF) 14, an attenuator (ATT) 16, an amplifier (AMP) 18, a microphone 19 and an engine controller 20.

The microcomputer 12 receives information on revolution number of the engine from the engine controller 20, for selectively generating a signal corresponding to the cancel sound by the sound control of ANC and generating a signal corresponding to the pseudo-engine sound by the sound control of ASC based on the engine revolution number.

FIG. 2 shows a correspondence relationship between the engine rotation number and the sound controls of ANC and ASC. In an example of FIG. 2, the microcomputer 12 generates the signal corresponding to the cancel sound by the sound control of ANC if the engine revolution number is less than or equal to 2500 rpm, while the microcomputer 12 generates the signal corresponded to the pseudo-engine sound by the sound control of ASC if the engine revolution number is not lower than 3000 rpm. The microcomputer 12 executes neither ANC nor ASC in the inactive range between 2500 and 3000 rpm of the engine revolution number.

The microphone 19 is installed in the vehicle interior for detecting the engine sound in that area. The microcomputer 12 receives the frequency and the amplitude of the engine sound that are detected by the microphone 19 when the sound control of ANC is performed. Then the microcomputer 12 generates the signal corresponding to the cancel sound which is a reverse phase of the detected sound and whose amplitude (or level) is a predetermined time (n times) than that of the detected sound.

The microcomputer 12 also retains a table in an internal memory, which stores a correspondence relationship between the engine revolution number and the output signal. FIG. 3 shows an example of the table, which shows the relationship between the engine revolution numbers and the output signals. The output signal is selected by an unique combination of the frequency and the amplitude (or level). In response to the engine revolution number from the engine controller 20, the microcomputer 12 retrieves the frequency and amplitude for the output signal in reference to the content of the table when the sound control of ASC is selected. The microcomputer 12 then produces the signal corresponding to the pseudo-engine sound with the retrieved frequency and amplitude. The signals corresponding to the cancel sound and to the pseudo-engine sound are outputted from the microcomputer 12 and are inputted to the LPF 14.

Furthermore the microcomputer 12 controls the operation of the ATT 16 as mentioned hereinafter. That is, the microcomputer 12 enables the different operations of the ATT 16 in response to the sound control of ANC or ASC. The detailed controls of the ATT 16 by the microcomputer 12 will be described hereinafter.

The LPF 14 receives the signals corresponding to the cancel sound and to the pseudo-engine sound from the microcomputer 12 and passes the signal below the predetermined cut-off frequency among the inputted signals. As a result, the noise exceeding the cut-off frequency in the signals corresponding to the cancel sound and to the pseudo-engine sound are eliminated. The signals corresponding to the cancel sound and to the pseudo-engine sound that are passed through the LPF 14 are inputted to the ATT 16.

The ATT 16 adjusts a sound volume. Only the signal corresponding to the cancel sound inputted through the LPF 14 is attenuated by the ATT 16 at a predetermined attenuation.

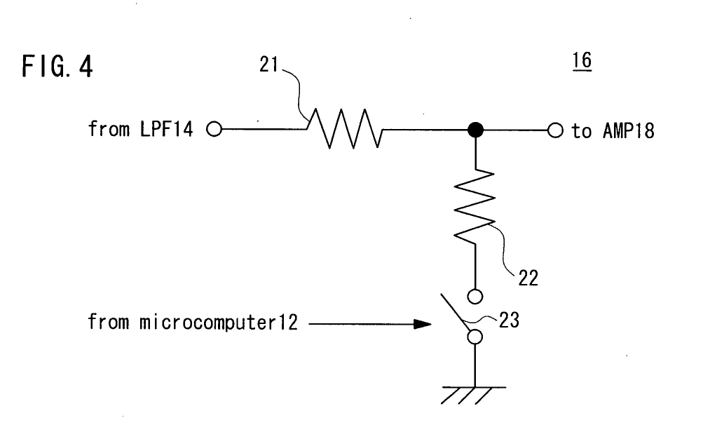

FIG. 4 shows circuitry of the ATT 16. The ATT 16 in FIG. 4 includes a resistor 21 and 22 and a switch 23. One end of the resistor 21 is coupled to an output of the LPF 14 and its other end is coupled to an input of the AMP 18. One end of the resistor 22 is connected to the input of the AMP 18. One end of the switch 23 is connected to other end of the resistor 22 and other end of the switch 23 is connected to ground.

The switch 23 is controlled by the microcomputer 12. Specifically the microcomputer 12 causes the switch 23 to be in an ON condition if the microcomputer 12 generates the signal corresponding to the cancel sound. Therefore, the signal corresponding to the cancel sound from the LPF 14 is attenuated by the ATT 16 at the predetermined attenuation based on the resistance of the resistor 21 and 22 and then the signal is inputted to the AMP 18.

As mentioned above, the microcomputer 12 generates the signal corresponding to the cancel sound which is the reverse phase of the detected engine sound and whose amplitude is n times than that of the detected engine sound. Therefore the ATT 16 needs to attenuate the inputted signal corresponding to the cancel sound at 1/n attenuation for making the amplitude of the signal equivalent to that of the engine sound.

Here, R1 is resistance of the resistor 21, R2 is resistance of the resistor 22, V is a amplitude of the signal corresponding to the cancel sound from the LPF 14 before the attenuation, the signal corresponding to the cancel sound after the attenuation is represented by V*R2/(R1+R2). Consequently each resistance of the resistors 21 and 22 is need to be satisfied with R2/(R1+R2)=1/n if the microcomputer 12 generates the signal corresponding to the cancel sound that is the reverse phase of the detected engine sound and whose amplitude is n times than that of the detected engine sound.

The microcomputer 12 also causes the switch 23 to be in an OFF condition in case the microcomputer 12 generates the signal corresponding to the pseudo-engine sound. Therefore, the signal corresponding to the pseudo-engine sound from the LPF 14 is inputted to the AMP 18 without the attenuation by the ATT 16.

The AMP 18 provides the signal corresponding to the cancel sound after the attenuation from the ATT 16 with a subsequent output stage (for example, a speaker), not shown here. By the output of the cancel sound, the engine sound of the interior of the vehicle is reduced. On the other hand, the AMP 18 provides the signal corresponding to the pseudo-engine sound from the ATT 16 with the subsequent output stage after a predetermined amplification. Then the pseudo-engine sound is outputted to the vehicle interior.

As described above, the microcomputer 12 of the sound control device according to the embodiment generates the signals corresponding to the cancel sound and to the pseudo-engine sound respectively based on the engine revolution number, and makes the switch 23 of the subsequent ATT 16 to be in the ON condition for attenuating the signal corresponding to the cancel sound if it is generated and makes the switch 23 to be in the OFF condition for passing the signal corresponding to the pseudo-engine sound without the attenuation if it is generated.

Consequently the microcomputer 12 that generates the sound signals is commonly used for the sound controls of ANC and ASC, and the ATT 16 that makes the attenuating means serves to attenuate only at the sound control of ANC. Thus both sound controls of ANC and ASC are performed by the single device, which makes the size of the device smaller.

Since the signal corresponding to the pseudo-engine sound is high amplitude and the signal corresponding to the cancel sound is low amplitude in general, the dynamic range of the sound signal in the microcomputer 12 comes to be large, and the quantifying noise may not be negligible if the cancel sound is low amplitude. However, the sound control device according to the embodiment can maintain the signal corresponding to the cancel sound with a high amplitude for outputting and the ATT 16 can attenuate it at a desired amplitude, thus the amplitude of the sound signal in the microcomputer 12 can be increased and the quantifying noise can be reduced.

As explained above, the sound control device of the present invention makes it possible to downsize the device and to use it for both the sound controls of ANC and ASC, therefore the sound control device of the present invention is useful.

What is claimed is:

1. A sound control device to be installed in an interior of a vehicle for controlling the sound in the interior of the vehicle, the sound control device comprising:
cancel sound signal generation means for generating a signal corresponding to the cancel sound for canceling an engine sound based on an engine revolution number when the engine revolution number is in a first range; and
pseudo-engine sound generation means for generating a signal corresponding to a pseudo-engine sound based on the engine revolution number when the engine revolution number is in a second range, the second range not being overlapped with the first range.

2. The sound control device according to claim 1, the sound control device further comprising a microphone for detecting an engine sound in the interior of the vehicle, the cancel sound signal generation means generating the signal corresponding to the cancel sound, which is a reverse phase of the detected engine sound and whose amplitude is n times than that of the detected engine sound, n being a number.

3. The sound control device according to claim 1, wherein the pseudo-engine sound generation means includes a memory for storing a relationship between the engine revolution number and the output signal with frequencies and amplitudes, and wherein the pseudo-engine sound generation means generates the signal corresponded to the pseudo-engine sound in reference to the content of the memory in response to a receipt of the engine revolution number.

4. A sound control device to be installed in an interior of a vehicle for controlling the sound in the interior of the vehicle, the sound control device comprising:
a sound signal generator for generating a signal corresponding to a pseudo-engine sound and a signal corresponding to a cancel sound for canceling an engine sound selectively based on an engine revolution number; and
an attenuator for receiving the signals corresponding to the cancel sound and to the pseudo-engine sound generated by the sound signal generator and for attenuating only the signal corresponding to the cancel sound.

5. The sound control device according to claim 4, the sound control device further comprising a controller for controlling an operation of the attenuating means in response to the engine revolution number.

6. The sound control device according to claim 5, wherein the attenuator includes a switch whose one end is coupled to an output of the sound signal generator and other end is coupled to a ground, and wherein the controller causes the switch to be in an ON condition for attenuating the signal corresponding to the cancel sound if it is generated by the sound signal generation means.

7. The sound control device according to claim 5, wherein the controller causes the switch to be in an OFF condition for passing the signal corresponding to the pseudo-engine sound without the attenuation.

8. The sound control device according to claim 4, wherein the sound signal generator includes a microphone for detecting the engine sound in the interior of the vehicle, and wherein the sound signal generator generates the signal corresponding to the cancel sound, which is a reverse phase of the detected engine sound and whose amplitude is n times than that of the detected engine sound, n being a number.

9. The sound control device according to claim 4, wherein the sound signal generator includes a memory for storing a relationship between engine revolution numbers and output signals with frequencies and amplitudes, and wherein the sound signal generator generates the signal corresponding to the pseudo-engine sound in reference to the content of the memory in response to a receipt of the engine revolution number.

10. The sound control device according to claim 4, the sound control device further comprising a low pass filter for receiving signals from the sound signal generator and for outputting the signals below the cut-off frequency to the attenuator.

11. The sound control device according to claim 4, the sound control device further comprising an amplifier for amplifying the signals corresponding to the cancel sound and to the pseudo-engine sound and a speaker for receiving the amplified signals from the amplifier for providing the cancel sound or the pseudo-engine sound with the interior of the vehicle.

12. The sound control device according to claim 4, wherein the sound signal generator comprises a sound signal generation means for generating the signal corresponding to the pseudo-engine sound and the signal corresponding to the cancel sound.

13. The sound control device according to claim 4, wherein the attenuator comprises attenuating means for receiving the signals corresponding to the cancel sound and to the pseudo-engine sound and for attenuating only the signal corresponding to the cancel sound.

14. A sound control device to be installed in an interior of a vehicle for controlling the sound in an interior of the vehicle, the sound control device comprising:
a microcomputer having a first input to receive information related to a revolution number of an engine of the vehicle and a second input to receive information relating to noise within the interior of the vehicle; and
an attenuator receiving an output of the microcomputer, the output carrying a signal related to a sound operation to be effected on the interior of the vehicle, the attenuator being controlled to a first level when the sound operation is a sound cancellation operation and a second level when the sound operation is a sound generation operation.

15. The sound control device of claim 14, further comprising:
an engine controller coupled to the first input of the microcomputer to provide the information related to the revolution number; and
a microphone coupled to the second input of the microcomputer to provide the information relating to the noise within the interior of the vehicle.

16. The sound control device of claim 14, further comprising a low pass filter coupled between the attenuator and the output of the microcomputer.

17. The sound control device of claim 16, further comprising an amplifier coupled to an output of the attenuator.

18. The sound control device of claim 14, wherein the attenuator is controlled in accordance with a control signal received from the microcomputer.

19. The sound control device of claim 14, wherein the microcomputer includes a memory for storing a relationship between the revolution number and a frequency and an amplitude, wherein the relationship is used when the sound operation is a sound cancellation operation.

20. The sound control device of claim 14, wherein the attenuator comprises:
an input node coupled to the output of the microcomputer;
an output node;
a first resistor coupled between the input node and the output node;
a second resistor coupled between the output node and a ground; and
a switch coupled between the output node and the ground in series with the second resistor, the switch being controlled by a control signal from the microcomputer.
